(19) United States
(12) Patent Application Publication
(10) Pub. No.: US 2026/0192213 A1
(43) Pub. Date: Jul. 9, 2026

(54) METHOD, USE, DEVICE AND CARTRIDGE FOR ENLARGING AEROSOL PARTICLES

(71) Applicant: Forschungszentrum Jülich GmbH, Jülich (DE)

(72) Inventors: Ulrich Bundke, Jülich (DE); Patrick Weber, Düren (DE)

(21) Appl. No.: 19/132,704

(22) PCT Filed: Nov. 9, 2023
(86) PCT No.: PCT/EP2023/081256

§ 371 Date: May 23, 2025

(30) Foreign Application Priority Data
Nov. 23, 2022 (DE) 102022212514.2

(51) Int. Cl. B01D 5/00

(52) U.S. Cl. CPC B01D 5/0045; B01D 5/0081

(57) ABSTRACT

The invention relates to a method and an apparatus for enlarging particles of an aerosol and to the use of an operating agent for producing a supersaturated vapor. In a method for enlarging particles (1) of an aerosol (2), the particles (1) come into contact with a supersaturated vapor (3). A sulfoxide or a sulfone such as dimethyl sulfoxide or dimethyl sulfone is used to produce the supersaturated vapor (3). These substances are non-flammable, non-hazardous to health, non-hazardous to the environment and therefore easy to handle. There is no odor nuisance or climatic damage. The same particle counting efficiencies are achieved as with the commonly used butanol as an operating agent.

The invention relates to a method and an apparatus for enlarging aerosol particles, the use of an operating agent for producing a supersaturated vapor and a cartridge.

Aerosol particles in the (lower) nanometer range cannot easily be detected optically. To optically detect such particles, they must first be enlarged. In the process, the particles grow by around two orders of magnitude, for example, so that optical detection is then possible. This can be the case in the region of 300 nm, for example. Enlargement can take place through condensation growth. This process is also known as activation. The particles act as condensation nuclei in an atmosphere of supersaturated vapor of an operating agent. The vapor molecules diffusively attach to the particle. The particles enlarged or grown in this way can then be detected using optical methods.

An aerosol is a mixture of solid and/or liquid particles in a gas. This gas is referred to as carrier gas. For the purposes of this application, the term gas comprises gas mixtures. The particles of an aerosol are also referred to as aerosol particles.

Technically, the particles are enlarged, for example, in a condensation particle counter (CPC). The operating agent is brought to a constant temperature in liquid form. This takes place in a saturator through which a stream of carrier gas flows. Depending on the temperature, a partial pressure of the operating agent, the saturation vapor pressure, is established in the carrier gas flow. The saturated carrier gas flow is fed into the condenser, which is cooler than the saturator. Due to the lower temperature, the partial pressure of the operating agent is now supersaturated. As soon as particles come into contact with this gas flow, they act as condensation nuclei and grow, accumulating the operating agent. An optical detector is used to detect the particles. For example, the gas flow can be irradiated with a focused light source, e.g., a laser. For example, radiation scattered by the particles can be detected. In this way, individual particles and/or numbers and/or concentrations of particles can be detected.

Alcohol such as butanol, ethanol or isopropanol is typically used as the operating agent for producing the supersaturated vapor. However, alcohols are flammable or highly flammable, have a strong odor and are harmful or toxic. Comprehensive safety measures are therefore necessary when handling and using them. In addition, the maximum temperature of the saturator and thus the maximum achievable supersaturation is limited due to the low flash point and/or boiling point of these substances. This leads to a limitation of the lower detection limit, as the level of supersaturation determines the critical diameter of the particles that can still be activated.

Diethylene glycol (DEG) can also be used as an operating agent in special cases. It is able to activate very small aerosol particles <2 nm at a saturator temperature of 50-60° C. However, particles activated with diethylene glycol only grow to approx. 100 nm, so that additional activation in a downstream CPC is necessary. In addition, diethylene glycol is also harmful to health.

It is also possible to use fluorinated hydrocarbons such as perfluorotributylamine, PFTBA, which is available under the Fluorinert brand, for example. These are used in the low-pressure range below 300 hPa. However, PFTBA requires a high saturator temperature of 190° C., which limits its use to a few special applications, and is also harmful to health and highly damaging to the climate.

The above-mentioned features, effects and definitions can be combined individually or in a plurality with the claimed and described subject-matter.

It is the task of the invention to improve the enlargement of particles of an aerosol, in particular for the optical determination of aerosol properties. Preferably, the aforementioned disadvantages of the prior art are to be at least partially eliminated.

The task is solved by the method according to claim 1 and the use, the apparatus and the cartridge according to the additional claims. Advantageous embodiments are given in the subclaims.

A method for enlarging particles of an aerosol, in which the particles come into contact with a supersaturated vapor, serves to solve the task. A sulfoxide or a sulfone is used to produce the supersaturated vapor.

A large number of sulfoxides and sulfones are not labeled with H-phrases (Hazard Statements) or P-phrases (Precautionary Statements) of the Globally Harmonized System of Classification and Labeling of Chemicals (GHS). The substances are not flammable, not harmful to health, not hazardous to the environment and therefore easy to handle. There is no odor nuisance or climatic damage. Overall, this significantly reduces the technical effort required and simplifies the elimination of particles. There are no restrictions on use in sensitive areas. Accordingly, the method can also be used in passenger transport, transportation, aerospace, the automotive sector, medicine, cleanrooms and laboratories, research, chemistry, biology and the environmental sector.

Sulfoxides and sulfones have similar physicochemical properties to butanol, which has often been used for particle enlargement, particularly with regard to vapor pressure, diffusion properties and the operating temperature range. Therefore, these groups of substances are well suited to serve as supersaturated vapor for particle entrainment. They represent an alternative to the standard operating agent 1-butanol and have considerably better properties. A further advantage consists in the fact that conventional devices such as condensation particle counters or components thereof can be used without or with only minor modifications to perform the method according to the invention.

To produce the supersaturated vapor, a sulfoxide or a sulfone is used according to the invention. This is also referred to in the following as the operating agent(s) according to the invention. In addition, another substance and/or a mixture of substances may be used to produce the supersaturated vapor. In one configuration, the supersaturated vapor is produced from a sulfoxide or a sulfone. The supersaturated vapor includes or consists of gaseous sulfoxide or sulfone.

Supersaturated vapor includes more gas particles than would be the case in thermodynamic equilibrium. Supersaturated steam therefore has a higher density than steam that is in thermodynamic equilibrium between steam and condensate. The vapor pressure is higher than the saturated vapor pressure. If condensation nuclei are added, condensation can occur in the supersaturated vapor, which can eventually lead to thermodynamic equilibrium.

The particles come into contact with supersaturated vapor. In particular, a non-supersaturated vapor is produced and converted into a supersaturated vapor by cooling. A non-supersaturated vapor can be a saturated or non-saturated vapor. The particles or the aerosol may already be present in the non-supersaturated vapor and may be cooled with it. The cooling process can then convert the non-supersaturated vapor containing particles into supersaturated vapor containing particles. It is therefore not necessary for the particles to be introduced into the already supersaturated vapor.

Sulfoxides are a class of chemical compounds with organically bound sulfur and the general structure R¹—S(═O)—R², where R¹ and R² are organic residues. Sulfones are a class of compounds with organically bound sulfur and oxygen with the general structural formula R¹—S(═O) 2-R², where R¹ and R² are organic residues.

The choice of organic residues, also known as ligands, can influence the melting and/or boiling temperature of the respective substance in both cases. This influences the vapor pressure. It is therefore easy to determine and use a suitable substance for the specific requirements. It is possible to use a mixture of several sulfoxides, several sulfones or at least one sulfoxide with at least one sulfone.

In one configuration, the method is performed in a particle counter, preferably in a CPC, in particular in an ultrafine aerosol condensation nucleus/particle counter.

In one embodiment, the supersaturated vapor is produced from dimethyl sulfoxide. In dimethyl sulfoxide (DMSO), the two organic residues are each methyl groups. Laboratory tests and field studies have shown that the enlargement of the particles with this substance provides particularly good results. The counting efficiency of optical particle counters is equivalent to that of particle counters operated with conventional butanol. The same applies to the activation size, in particular the minimum (critical) activation size. DMSO is inexpensive, readily available and, due to the low vapor pressure of DMSO, only a fraction of the operating agent is consumed compared to butanol, for example (approx. 10% of the consumption of butanol).

In one embodiment, the supersaturated vapor is produced from dimethyl sulfone. In dimethyl sulfone, the two organic residues are each methyl groups. The enlargement of the particles provides particularly good results with this substance. The counting efficiency of optical particle counters is comparable to particle counters operated with conventional butanol.

The use of organic residues such as ethyl or cyclic (cyclo) compounds is possible for both sulfones and sulfoxides. Symmetrical or asymmetrical sulfones or sulfoxides can be used.

In one embodiment, the particles have a diameter of less than 50 nm, in one configuration less than 23 nm, in particular less than 10 nm and preferably less than 5 nm or less than 3 nm. The particles have the said diameter before coming into contact with the supersaturated vapor. In particular, average diameters of a plurality of particles are meant. For example, this is d₅₀. Starting from this diameter, growth or enlargement then takes place.

It has been shown that even very small particles can be enlarged using the operating agent according to the invention. In particular, these particles can be optically detected after enlargement.

In one embodiment, the supersaturated vapor is produced by cooling non-supersaturated vapor. In one embodiment, the non-supersaturated vapor is produced at a temperature above 30° C., preferably above 40° C., in particular above 60° C.

The operating agents according to the invention have high flash points and high boiling points compared to previously used substances such as 1-butanol. Therefore, a higher temperature can be used according to the invention. Butanol, for example, has a flash point of 35° C., so that higher temperatures are not possible with this operating agent from a practical point of view.

The higher temperatures enable higher supersaturation and thus larger and faster growth. Ultimately, a particularly low detection limit (of the activatable particle size) can be achieved in terms of particle size. In particular, the temperatures mentioned prevail in a saturator.

A maximum temperature for DMSO can be 150° C., as thermal decomposition occurs above this temperature. If other substances are used, the maximum temperature can be higher; in the case of dimethyl sulfone, for example, above 230° C. The maximum temperature can be set over a wide range by selecting suitable organic residues. In one embodiment, the non-supersaturated vapor is produced at a temperature above 80° C., in particular above 110° C. In this way, a particularly low detection limit can be achieved down to nanoparticles below 5 nm or below 2 nm, in particular without an additional activation stage. This can be done in particular at a condenser temperature of 5° C. to 10° C.

In one embodiment, the supersaturated vapor is produced by cooling non-supersaturated vapor to a temperature below 20° C., in particular below 10° C. In particular, the temperature is more than 0° C. or more than 5° C. This target temperature can be set using particularly simple technical means.

In one embodiment, the supersaturated vapor is produced by cooling non-supersaturated vapor to room temperature and/or a temperature above 15° C., in particular 20° C. and/or below 30° C., in particular 25° C. In many applications, this target temperature can be set entirely without technical means or at least without cooling. Cooling, for example by means of Peltier elements, can thus be dispensed with. If necessary, a heating device can be provided to increase the temperature if required. Heating is technically much less complex than cooling. Due to the operating agent according to the invention, a saturator temperature as low as in conventional apparatuses is no longer necessary. Sufficient supersaturation can also be achieved with higher condenser temperatures due to the higher saturator temperatures.

In one embodiment, a mixture of sulfoxide or sulfone with water is used to produce the supersaturated vapor. In particular, the sulfoxide or sulfone used to produce the supersaturated vapor is diluted with water. The use of water alone as an operating agent is not possible due to its diffusion properties. However, it has been shown that a mixture of the operating agent according to the invention with water leads to an effective enlargement of the particles. At the same time, different mixing ratios allow the melting point of the respective sulfoxide or sulfone to be adapted to the respective operating conditions or requirements.

The melting point of DMSO can be reduced from 18° C. to, for example, 5° C. to 15° C. by adding small amounts of water. For example, under the cockpit of an airplane, where a particle counter can be operated to investigate atmospheric aerosols, temperatures between 5° C. and 15° C. can prevail. When diluted with water, the particle counter can also be operated under these conditions without additional technical effort, for example when diluted with 10% water by volume up to −10° C. There is then no need to worry about the operating agent solidifying or freezing in reservoirs or pipes.

In particular, the supersaturated vapor is produced from the sulfoxide or sulfone diluted with water. Typically, the water is used as a diluent.

In one embodiment, the volumetric proportion of water in the mixture is less than 10%. It has been shown that up to a water content of 10% in the total volume of the mixture, there is no significant impairment of the counting efficiency of a particle counter. In other words, reliable results are obtained up to this water content. In one configuration, the water content is less than 5%. This achieves particularly accurate results. The water does not affect the enlargement of the particles.

In one embodiment, the particles are enlarged under negative pressure. In particular, the negative pressure is between 150 hPa and 750 hPa. Typically, the producing of the non-supersaturated vapor and/or an optical determination also takes place under the negative pressure. The pressure mentioned is an absolute pressure.

In one embodiment, the enlarged particles are detected optically. In one embodiment, a number of particles is determined. In one configuration, at least one property of the aerosol is determined optically after the particles of the aerosol have been enlarged. The optical determination can, for example, be a detection of a number of particles, for example in a certain volume and/or a certain time interval. The optical determination can also be an optical detection of a property of one or more particles. For example, a size of a particle and/or an average size of several particles can be determined. A size typically means a diameter. Preferably, a number concentration of the particles can be determined.

After the particles have been enlarged, a gas volume or gas flow with enlarged particles is typically present. In one configuration, the gas volume or gas stream is irradiated with light, in particular by means of a focused light source such as a laser. In one configuration, an optical detector is provided for detecting the enlarged particles. In one configuration, the detector is configured to detect scattered radiation. In particular, evaluation electronics are provided to determine a number, concentration or number concentration of the particles from signals received from the detector. For example, the evaluation electronics are configured to count a number of particles, for example in a certain time interval. In one configuration, the evaluation electronics have access to information on a volume flow or volume of the gas.

In one embodiment, the aerosol is selected from ambient air, combustion exhaust gas, production exhaust gas, supply air of a cleanroom, exhaust air of a cleanroom, supply air of a substantially enclosed space and exhaust air of a substantially enclosed space. A cleanroom can be, for example, a cleanroom in the chemical industry, the pharmaceutical industry, chip production, a hospital or a laboratory, such as an S0, S1, S2, S3 or S4 laboratory. The supply air of a cleanroom can be analyzed for monitoring purposes. The exhaust air of a cleanroom may be an air flow that is discharged separately for detection (room air monitoring) or an exhaust air flow for venting the cleanroom that is present independently of this. Cleanroom exhaust air can be analyzed for the purpose of monitoring the condition and/or contamination of the cleanroom. A production exhaust gas can, for example, originate from industry, medicine, medical technology, pharmacy, chemistry or a military application. In particular, the method or use can be used to determine a dust and/or aerosol load, optimize a process, analyze combustion residues, monitor quality, investigate a climate relevance, investigate a particle load, avoid a hazard, assess a risk and/or control a production. Ambient air refers in particular to air from a specific area of the earth's atmosphere. In the case of a combustion exhaust gas, this can be an exhaust gas from a combustion engine such as a diesel or gasoline engine. This can take place during engine development, combustion optimization and/or technical monitoring of engines or vehicles. It can be an internal combustion engine of a motor vehicle, aircraft, ship or rail vehicle. In particular, the particle number or a value derived therefrom such as the particle number concentration, which corresponds to the particle number per volume, the particle number per time or the particle number per time and power can be used.

A substantially enclosed space can be a passenger compartment, e.g., an airplane cabin. Here, the quality of a supply and/or exhaust air can be measured in order to determine and/or adjust the quality of the cabin air.

In one embodiment, the aerosol includes lipophilic and/or insoluble particles. Insoluble particles may comprise, for example, silicates and/or mineral dusts. Lipophilic particles can be enlarged with the operating agent according to the invention just as well as hydrophilic particles. The lipophilic particles may be hydrophobic. In one configuration, the aerosol includes hydrophilic particles. The hydrophilic particles may be lipophobic. In one configuration, the aerosol includes lipophilic and hydrophilic particles. In one configuration, the aerosol includes organic particles. Any combinations are possible. In one configuration, substantially all of the particles of the aerosol are lipophilic and/or hydrophilic.

In one embodiment, the particles are enlarged at an altitude of more than 500 m above the earth's surface and/or from an aircraft.

Preferably, the altitude is more than 1,000 m, in one configuration more than 5,000 m above the earth's surface, and/or less than 20,000 m, in one configuration less than 15,000 m above the earth's surface. Additionally or alternatively, the enlargement takes place in or on an airplane. In particular, the particles are also counted at the aforementioned altitude. In this way, aerosols present at different heights in the atmosphere can be investigated. Due to current safety regulations, the use of butanol in passenger aircraft is practically no longer permitted. However, the operating agents according to the invention still allow this.

A further aspect of the invention is the use of a sulfoxide or a sulfone for producing a supersaturated vapor. The supersaturated vapor comes into contact with the particles of an aerosol for the purpose of enlarging the particles. In particular, a number of the enlarged particles is detected with a particle counter. All features, advantages and effects of the method described at the beginning apply accordingly to the use and vice versa.

A further aspect of the invention is an apparatus, in particular a part of a condensation particle counter or a condensation particle counter. This comprises a condenser for enlarging particles of an aerosol by means of a supersaturated vapor. A reservoir for a sulfoxide or sulfone is provided to produce the supersaturated vapor. In particular, the reservoir includes the sulfoxide or sulfone. In particular, the condensation particle counter further comprises a saturator for producing a non-supersaturated vapor. All features, advantages and effects of the method described at the beginning apply accordingly to the apparatus and vice versa.

In particular, the apparatus or the condensation particle counter does not include a cooling device for cooling the condenser. Since the higher saturator temperatures in the operating agents according to the invention allow for sufficient supersaturation even with slightly higher condenser temperatures, cooling, for example electrical cooling, can be dispensed with in order to simplify the apparatus. This is reinforced by the fact that at low temperatures, the effects of temperature differences on the partial pressure of the operating agent are small compared to high temperatures. This means that no cooling elements, no fan, no associated control and no heat sinks for the warm side are required. Overall, the installation space of the apparatus can thus be significantly reduced.

In one configuration, the apparatus is part of a condensation particle counter for analyzing a combustion exhaust gas, in particular for technical monitoring of vehicles such as motor vehicles, aircraft, ships and/or rail vehicles. In one configuration, the apparatus has a d₅₀ of 23 nm. The apparatus can be a condensation particle counter according to the European Committee for Standardization CEN.

In the following, exemplary embodiments of the invention are also explained in more detail with reference to figures. Features of the exemplary embodiments may be combined individually or in a plurality with the claimed subject-matter, unless otherwise indicated. The claimed scopes of protection are not limited to the exemplary embodiments.

The figures show:

FIG. 1: an experimental setup,

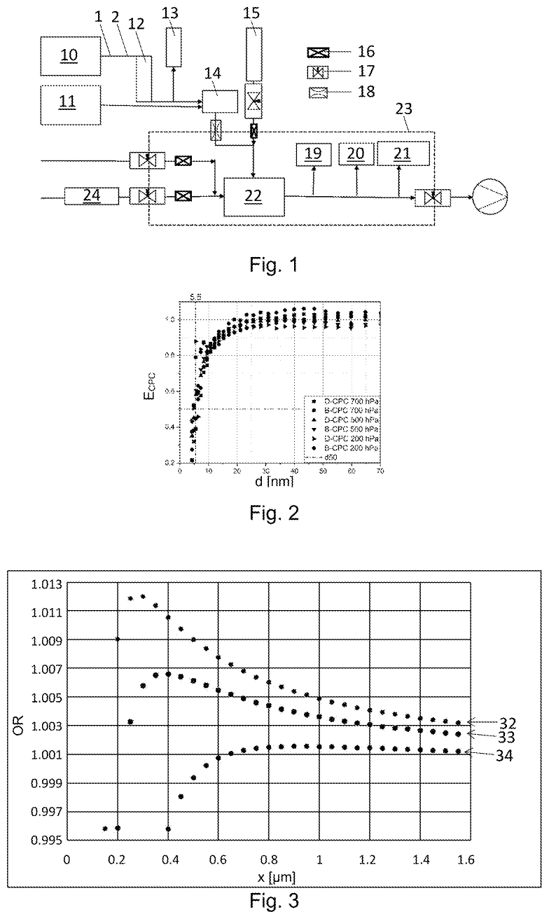

FIG. 2: counting efficiency curves,

FIG. 3: a Kelvin-Koehler diagram,

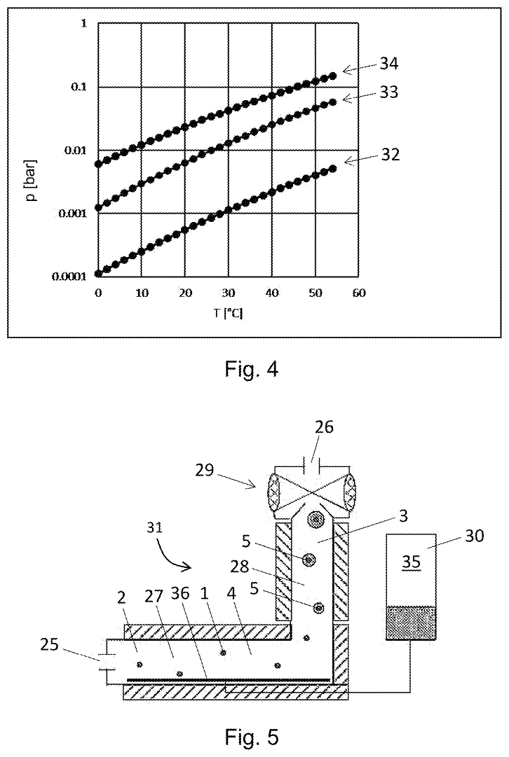

FIG. 4: vapor pressure curves,

FIG. 5: a schematic setup of a condensation particle counter.

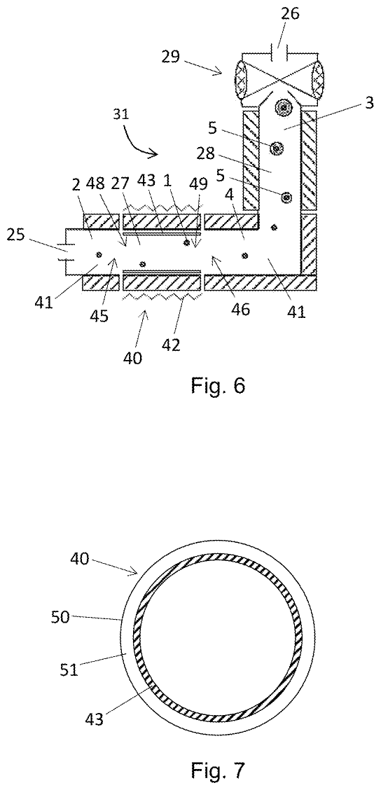

FIG. 6: a schematic structure of another condensation particle counter, and

FIG. 7: a cartridge according to the invention.

FIG. 1 shows a test setup for investigating a condensation particle counter 21 with an aerosol 2 produced for test purposes for the purpose of evaluating different operating agents. The aerosol 2, which includes the particles 1, is produced in an aerosol source 10, e.g., a nebulizer, and then initially fed into a size selector 14 via drying 12 and regulation of excess air 13. Preferably, a differential mobility analyzer (DMA) is used, which only allows particles of a certain size to pass through and in this way produces a monodisperse aerosol.

In addition, soot particles produced by means of a soot generator 11 can also be directed to the size selector 14. The aerosol is fed into the mixing chamber 22, which is part of a low-pressure area 23, via an opening 18 and a line. The line is connected to a flow control 15 via a particle filter 16 and a mass flow controller 17. There is also a humidifier 24 to influence the humidity in the mixing chamber 22. A device for diluting and/or controlling the pressure of the atmosphere in the mixing chamber 22 is located above the humidifier 24. Both devices are each connected to the mixing chamber 22 with a mass flow controller 17 and a particle filter 16. There is also a temperature control for the mixing chamber 22.

Several measuring devices are connected to the mixing chamber 22 via an outlet line: a reference measuring instrument 19 for determining the number concentration, for example a Faraday cup electrometer, a condensation particle counter 20 with a conventional operating agent such as 1-butanol, and the condensation particle counter 21 with the operating agent according to the invention.

Soot particles are hydrophobic and lipophilic and insoluble in water. The particles produced with the nebulizer are in particular hydrophilic and lipophobic. By using both devices, different aerosols and possibly mixtures can be investigated.

FIG. 2 shows a diagram with curves for the counting efficiency of different operating agents. In particular, the data shown has been recorded with the device shown in FIG. 1. The counting efficiency E_{CPC} of the particle counter is plotted against the diameter d of the particles in nanometers. The diameter d is the mobility diameter, which was measured using the DMA. The individual curves refer to a condensation particle counter B-CPC operated conventionally with butanol and an identical D-CPC operated with the operating agent DMSO according to the invention. The counting efficiency was standardized to the measured values of the reference measuring instrument 19 (see FIG. 1). With each of the CPCs, measurements were performed under different negative pressures, namely 200 hPa, 500 hPa and 700 hPa.

It can be seen that there are no differences in the counting efficiency E_{CPC} between the different operating agents at each pressure level. It is also shown that the cut-off point, also known as the d₅₀ point, is 5.5 nm for both CPCs, regardless of the pressure used. The change to the operating agent according to the invention, shown here using DMSO as an example, therefore has no influence on the counting efficiency.

FIG. 3 shows a Kelvin-Koehler diagram for the operating agents DMSO 32, butanol 33 and water 34, with the supersaturation ratio OR plotted against the droplet diameter x of the respective operating agent in μm. A NaCl particle with a diameter of 13 nm at 20° C. was considered. The supersaturation ratio OR corresponds to the saturation quotient and is calculated as the quotient of the saturation vapor pressure over the curved surface of a particle and the saturation vapor pressure over a flat surface. The maximum of the curve defines the critical radius and the critical supersaturation. As soon as this point is exceeded, i.e., to the right of the respective maximum in the diagram, particles are activated and continue to grow steadily in a non-equilibrium state. In this way, growth can take place over several orders of magnitude.

If the saturation quotient is greater than 1, supersaturation is present. For particles to grow, the saturation quotient must be above the respective curve; if it is below, the deposited operating agent evaporates. It can be seen that a supersaturation of 1.2% is required when using DMSO 32 and a supersaturation of only 0.7% for butanol 33. It is also possible to produce a supersaturation of 1.2% with commercially available CPC without any problems.

FIG. 4 shows vapor pressure curves for the operating agents DMSO 32, butanol 33 and water 34. The vapor pressure p in bar is plotted on a logarithmic axis over the temperature in ° C. Since the vapor pressure of DMSO 32 is an order of magnitude lower than that of butanol 33, the loss of operating agents and thus the consumption is significantly reduced in the case of DMSO 32. This reduction could be confirmed experimentally. The same applies to other operating agents according to the invention. Moreover, since the curves of butanol 33 and DMSO 32 run in parallel, the supersaturation is similar for the same temperature difference between saturator and condenser. For this reason, DMSO 32 behaves similarly to butanol 33 as an operating agent.

FIG. 5 shows an apparatus according to the invention and/or a condensation particle counter 31 for performing the method according to the invention. Following an inlet 25 for supplying the aerosol 2 with the particles 1 is a saturator 27 for producing a non-supersaturated vapor 4. A humidifier 36 is located in the saturator, which is designed, for example, as a sponge or similar component with a large surface area. The humidifier can be arranged on one or more walls inside the saturator 27. A reservoir 30 with an operating agent 35, namely a sulfoxide or sulfone, is connected to the humidifier 36 in order to produce the non-supersaturated vapor 4. For this purpose, the operating agent 35 evaporates at the humidifier 36 at a first temperature, which is typically below the boiling temperature of the operating agent 35 used.

The gas flow is then cooled to produce the supersaturated vapor 3. This takes place in a condenser 28 for enlarging particles 1 of the aerosol 2. The supersaturated vapor 3 comes into contact with the particles 1 of the aerosol 2, which subsequently grow.

An optics 29 is arranged between the condenser 28 and the outlet and is used to detect the particles. The particles can be counted using evaluation electronics connected to the optics 28. In particular, the apparatus comprises the evaluation electronics.

The particle growth is shown schematically. While in the saturator 27 the size of the particles 1 only grows slowly up to the equilibrium radius, the particles grow rapidly over several orders of magnitude with increasing residence time in the condenser 28 in the disequilibrium (activated), so that enlarged particles 5 with an increased diameter are formed.

FIG. 6 shows an apparatus according to the invention and/or a condensation particle counter 31 for performing the method according to the invention. In order to avoid duplication, only differences to the apparatus of FIG. 5 are described. The apparatus comprises a replaceable cartridge 40 with a solid sulfone 43. The cartridge 40 may be mechanically connected to the rest of the apparatus. The connection points for this purpose are shown schematically as gaps. The apparatus may have a heating device 42 for directly or indirectly heating the cartridge 40 and/or the solid sulfone 43 contained therein. The cartridge 40 serves in particular as a saturator 27.

In one configuration, the apparatus includes one or more flow paths 41 for the aerosol 2. A flow path 41 of the apparatus may include an outflow interface 45 for transferring the aerosol 2 into the cartridge 40 and/or an inflow interface 46 for transferring the aerosol 2 out of the cartridge 40. In one configuration, the cartridge 40 includes an inlet port 48 for introducing the aerosol 2 received from the outflow interface 45 into the cartridge 40. In one configuration, the cartridge 40 includes an outlet port 49 for discharging the aerosol 2 from the cartridge 40 into the inflow interface 46 of the apparatus.

The condenser 28 and/or the optics 29 can be designed similarly to FIG. 5. The particle growth is also shown schematically here.

FIG. 7 shows a cross-section of a cartridge 40 according to the invention. The cartridge 40 comprises a tube 50 with an outer wall 51. The wall 51 may consist of a metal. Solid sulfone 43 is arranged on the inside of the outer wall. This is arranged, for example, as a continuous and/or circumferential layer with an essentially constant thickness. As shown, the thickness of the layer can be less than the thickness of the wall or can be of the same thickness or thicker. The layer thickness can be different in different sections of the tube 50, in particular in relation to the longitudinal extension of the tube 50. Thus, a different layer thickness may be present in an inlet area of the tube than in an outlet area of the tube. The solid sulfone 43 has comparatively poor thermal conductivity, so that more energy is required for heating if the layer thickness is large. Therefore, the layer thickness can be selected so that an optimum between energy efficiency and service life of the cartridge 40 is achieved depending on the requirements. The layer thickness is also a measure for the filling level of the cartridge 40 with the solid sulfone and/or for the remaining capacity of the cartridge 40. The layer thickness and thus the capacity of the cartridge 40 can be determined indirectly via the heating and/or the energy required for this. The circular cross-section shown in FIG. 7 is advantageous because such a cartridge can be installed in an existing particle counter without any modifications and used with it.

In one embodiment, a solid sulfone is used. This makes handling particularly easy.

In one embodiment, the apparatus comprises a mixing device for producing a mixture of a sulfoxide and water. The mixing device may be such that predetermined amounts of sulfoxide and water are mixed in a flow to be fed directly to an evaporation device to produce the supersaturated vapor. The mixing can be continuous, at least for periods of time. The mixing device may be such that there is a mixing vessel into which predetermined quantities of sulfoxide and water are added. In this way, the mixture can be produced in batches. The mixing device can be automatic and/or controlled by a control. In this way, a suitable mixture can be produced in an automated manner.

In an alternative or complementary embodiment, the reservoir is configured to receive a mixture of a sulfoxide and water.

If the supersaturated vapor is produced from the sulfoxide or sulfone diluted with water, the water can serve as an antifreeze agent.

In one embodiment, the volumetric proportion of water in the mixture is less than 60%, for example about 46%. In one embodiment, the proportion of water in the mixture is less than 40 mol %, for example about 30 mol %. Pure dimethyl sulfoxide (DMSO) has a melting point of 18° C. A mixture of, for example, dimethyl sulfoxide with water containing 30 mol % DMSO, approximately corresponding to 43% by volume, can lower the melting point to about −140° C. In this way, the invention can also be used at very low temperatures. This is advantageous, for example, for measurements in or on an airplane or in the Antarctic. This opens up further areas of application.

In one embodiment, the reservoir is designed as a cartridge which includes, for example, a solid sulfone. The sulfone can be dimethyl sulfone, for example. The cartridge is particularly interchangeable. This means that a used or emptied cartridge can be removed from the apparatus in order to replace it with a new or filled cartridge. The cartridge can be permanently installed or be present as a separate, mechanically detachable module. In the latter case, the cartridge can be located upstream of the apparatus and/or upstream of the particle counter.

The cartridge can therefore be replaceable in the same way as a printer cartridge. In particular, the cartridge and/or the apparatus is designed in such a way that the aerosol with the particles to be enlarged can be guided through the cartridge. In one configuration, the cartridge and/or the sulfone arranged in the cartridge includes a through opening through which a flow of the aerosol can be directed. The through opening then acts as a flow path for the aerosol. This allows the aerosol to come into contact with the sublimated sulfone.

In one configuration, the cartridge can be heated. In particular, the cartridge comprises an outer wall, preferably made of a material with good thermal conductivity, such as a metal, for example copper. The sulfone can be arranged inside the outer wall. The outer wall is designed in particular in such a way that a heat source positioned outside the outer wall can heat the sulfone through the wall. In particular, the apparatus comprises a heat source configured to heat the cartridge located in the apparatus. In particular, the heat source is configured such that it is arranged outside the outer wall of the cartridge and can heat the outer wall so that the sulfone can be heated through the outer wall. Alternatively or additionally, the cartridge can have a heat source, which can be designed as described.

In one configuration, the cartridge can be heated differently in different sections, in particular in relation to the longitudinal extension of the cartridge or the tube. For example, different temperatures can be realized in different sections. Different sections of the cartridge or the tube can be composed of separate components and/or be thermally insulated from each other. The heating device can be configured to realize different temperatures in different sections of the cartridge.

For example, heating to a temperature of at least 35° C., in particular at least 40° C., preferably at least 50° C., particularly preferably at least 60° C. and/or of at most 150° C., in particular at most 130° C., preferably at most 90° C., particularly preferably at most 70° C. is provided. In other words, the cartridge and/or the apparatus is configured such that such heating is possible.

It has been shown that a solid sulfone partially sublimates at a temperature of, for example, at least 35° C. or 40° C., and is capable of enlarging particles of the aerosol by condensation. It has been shown that such a solid sulfone is easy to handle and very economical. No storage bottle, no hoses and no porous material are required for vaporization. Such a solid sulfone can be used in existing condensation particle counters. In addition, the solid sulfone can also be used in the temperature range of existing condensation particle counters. The use of the solid sulfone in direct contact with the aerosol is particularly advantageous and simple. A cartridge with the solid sulfone can be easily exchangeable and achieve reproducible results.

In principle, the cartridge can be of any shape. In one configuration, the cartridge comprises a tubular section or is designed as such. The tubular section can be straight. A tubular outer wall of the cartridge may then comprise the sulfone. The sulfone is located in particular as a layer inside the cartridge and/or on the inside of the outer wall. The layer preferably has a thickness of less than 3 cm, in particular less than 1 cm and in one configuration less than 0.5 cm or less than 0.2 cm. The layer thickness is in particular greater than 1 μm. A central passage opening can be formed along the longitudinal axis of the tube as a flow path for the aerosol. This configuration is particularly simple and inexpensive to manufacture.

In one configuration, the cartridge is curved or spiral-shaped. For example, a tubular section of the cartridge is bent or spiral-shaped. In this way, a longer path can be provided with a small volume of the cartridge.

A further aspect of the invention is a cartridge comprising a solid sulfone for enlarging particles of an aerosol and/or for use in an apparatus for enlarging particles of an aerosol. The apparatus may be an apparatus according to the invention. The sulfone can be, for example, dimethyl sulfone. In particular, the cartridge is designed in such a way that the aerosol with the particles to be enlarged can be passed through the cartridge. All features, properties and advantages of the above-mentioned method and apparatus also apply to the cartridge and vice versa. Filling of a cartridge can take place with molten and/or liquid sulfone and/or with powdered sulfone.

A further aspect of the invention is a use of a cartridge with a solid sulfone for enlarging particles of an aerosol and/or in an apparatus for enlarging particles of an aerosol. The above embodiments, features, advantages and effects of the method, use and apparatus also apply to the cartridge and vice versa.

### LIST OF REFERENCE SIGNS

Particles 1
Aerosol 2
Supersaturated vapor 3
Non-supersaturated vapor 4
Enlarged particle 5
Aerosol source 10
Soot generator 11
Drying 12
Excess air 13
Size selector 14
Flow control 15
Particle filter 16
Mass flow controller 17
Opening 18
Reference measuring instrument 19
Condensation particle counter 20
Condensation particle counter 21
Mixing chamber 22
Low-pressure area 23
Humidifier 24
Inlet 25
Outlet 26
Saturator 27
Condenser 28
Optics 29
Reservoir 30
Condensation particle counter 31
DMSO 32
Butanol 33
Water 34
Operating agent 35
Humidifier 36
Supersaturation ratio OR
Mobility diameter d
Counting efficiency (d particle counter) E_{CPC}
Vapor pressure p
Diameter X
Cartridge 40
Flow path 41
Heating device 42
Solid sulfone 43
Outflow interface 45
Inflow interface 46
Inlet port 48
Outlet port 49
Tube 50
Wall 51

1. Method for enlarging particles of an aerosol, the method comprising
bringing the particles into contact with a supersaturated vapor, and
using a sulfoxide or a sulfone for producing the supersaturated vapor.

2. The method of claim 1, wherein the supersaturated vapor is produced from dimethyl sulfoxide or from dimethyl sulfone.

3. The method of claim 1, wherein the particles have a diameter of less than 50 nm.

4. The method of claim 1, wherein the supersaturated vapor is produced by cooling non-supersaturated vapor, wherein the non-supersaturated vapor is produced at a temperature above 30° C.

5. The method of claim 1, wherein the supersaturated vapor is produced by cooling non-supersaturated vapor to a temperature above 10° C. and/or below 30° C.

6. The method of claim 1, wherein a mixture of the sulfoxide or sulfone with water is used for producing the supersaturated vapor.

7. The method of claim 1, wherein the enlargement of the particles takes place under negative pressure, and wherein the negative pressure is in particular between 150 hPa and 750 hPa.

8. The method of claim 1, wherein the enlarged particles are optically detected and a number of particles is determined.

9. The method of claim 1, wherein the aerosol includes lipophilic and/or insoluble particles.

10. The method of claim 1, wherein the method for enlargement of the particles of an aerosol is carried out at an altitude of more than 500 m above the earth's surface.

11. A method of use of a sulfoxide or a sulfone for producing a supersaturated vapor, wherein the supersaturated vapor comes into contact with particles of an aerosol for enlarging the particles.

12. Apparatus for enlarging particles of an aerosol, the apparatus comprising
a condenser for enlarging particles of an aerosol by means of a supersaturated vapor,
wherein a reservoir for a sulfoxide or sulfone is provided for producing the supersaturated vapor.

13. The apparatus of claim 12, wherein the apparatus comprises a mixing device for producing a mixture of a sulfoxide and water.

14. The apparatus of claim 12, wherein the reservoir is designed as a cartridge, which contains a solid sulfone.

15. The method of claim 3, wherein the particles have a diameter of less than 10 nm.

16. The method of claim 4, wherein the non-supersaturated vapor is produced at a temperature above 60° C.

17. The method of claim 4, wherein the non-supersaturated vapor is produced at a temperature above 80° C.

18. The method of claim 4, wherein the non-supersaturated vapor is produced at a temperature 110° C.

19. The apparatus of claim 14, wherein the cartridge is designed such that the aerosol with the particles to be enlarged can be guided through the cartridge.
